(19) United States
(12) Patent Application Publication
(10) Pub. No.: US 2026/0274555 A1
(43) Pub. Date: Sep. 17, 2026

(54) IMPROVEMENTS IN HANDLING BULK MATERIAL FEEDSTOCKS

(71) Applicant: Itero Technologies Limited, South Buckinghamshire (GB)

(72) Inventors: Geoff Smith, Reigate (GB); James Helliwell, London (GB); Adam Niall Benjamin Smith, London (GB); David Nessbach, Wendover (GB)

(21) Appl. No.: 19/480,176

(22) PCT Filed: May 3, 2024
(86) PCT No.: PCT/EP2024/062322

§ 371 Date: Oct. 30, 2025

(30) Foreign Application Priority Data
May 5, 2023 (GB) 2306684.8

(51) Int. Cl. B65D 88/68; B65D 88/32; B65G 3/04; B65G 65/46; C10B 53/07

(52) U.S. Cl. CPC B65D 88/68; B65D 88/32; B65G 3/04; B65G 65/46; C10B 53/07

(57) ABSTRACT

Innovations are provided in the field of handling bulk materials, especially mixed plastic waste, with an improved hopper system and systems for use in hoppers directed to prevent bridging.

### FIELD OF THE INVENTION

The invention relates to innovations in the handling of bulk material feedstocks, particularly in conjunction with feedstock entry systems for pyrolysis of plastic waste.

### BACKGROUND

Pyrolysis of mixed plastic waste has great potential as a circular solution to the ever-increasing plastic waste problem, especially as a means to reduce the carbon emissions of the disposal of waste plastic and also the formation of new plastic. Pyrolysis of plastic is optimal only for certain types of polymers in forms that would otherwise not be suitable for mechanical recycling. This includes multi-layer films, mixed plastic wastes, other films and plastics contaminated with substances that make separation and cleaning difficult.

Henceforth this plastic waste, as a feedstock for pyrolysis, will be called ‘Mixed Plastic Waste’ (MPW). Furthermore, industrial plastic waste (IPW), or waste that originates from industrial sources can have a design that specifically makes it difficult to recycle mechanically. This may be because of melt viscosity, layering of films or additives.

Notably, MPW and IPW can have a large variety of characteristics based on location of delivery, type of waste and season. As these wastes are not necessarily mechanically recyclable, they can have high levels of contamination such as moisture, sand, metals, or trace elements. Handling a feedstock with no well-defined characteristics and such a variety of compositions is incredibly difficult.

Currently the chemical recycling field turns to extrusion as a feeding system for MPW and IPW to a continuous pyrolysis reactor. Extrusion has many benefits as it homogenises the feedstock, it pre-heats the feedstock, increases density upon delivery, and provides a safe transition from oxygen rich atmosphere to oxygen deficient, decomposable atmosphere (required for pyrolysis). However, extrusion systems have specifications that are more stringent than pyrolysis systems based on throughput, operational consistency, maintenance requirements, feedstock compositional properties, feedstock mechanical properties, and the mechanical constraints of the equipment. Examples of relevant feedstock compositional properties can include (but are not limited to) moisture content, sand, organic content and metal content.

These represent criteria which are especially likely to vary in MPW and IPW, creating enormous difficulties in using such extrusion systems with these types of feedstock. With extrusion systems in particular, it has proved necessary to perform significant amounts of pre-processing, necessitating the installation of feedstock processing plants that take up a lot of space and require a lot of capital expenditure.

Extrusion systems also consume a significant amount of electrical energy during operation, something which must be taken from the grid. Generating electricity from the plastic pyrolysis by-product gas reduces efficiency versus thermal uses for the pyrolysis gas, so any efficiency gained from heating the product prior to pyrolysis is lost.

Extrusion systems therefore have many drawbacks, but remain a solution widely explored in the field of pyrolysis of MPW and IPW in part because MPW and IPW are extremely difficult to handle, and extrusion is regarded as a solution to that.

Most bulk storage and conveying systems deal with materials that can be treated as incompressible and free flowing, whereas MPW/IPW is low density, high compressibility and non-Eulerian in flow behaviour. Consequently, existing material handling systems that are well known in the industry perform poorly in conjunction with MPW and IPW.

Well-known bulk material conveying solutions include providing mechanisms such as a walking floor, conveyor belt(s), designing the hooper such that its walls converge to a single screw, or lining the hopper base with a multi-screw mechanism. Both walking floor systems and conveyor belt systems are good for dense feedstocks but the nature of MPW/IPW and the presence of residual back flow gases from the pyrolysis reactor has the potential to cause issue with such mechanisms (through corrosion and deposition of sticky deposits) and introduce extra sealing problems from the outside atmosphere. Agglomeration prior to feedstock handling simplifies the density problems associated with MPW and IPW but has similar energy usage to extrusion and can have problems with high melt viscosity feeds. It also restricts the acceptable contamination levels of sand/metals within the feedstock.

Similarly, hopper or silo based systems have been extensively used in the handling of bulk materials. Tall and narrow silos or hoppers constitute a traditional design and are very common in many industrial applications, since they have an efficient footprint area, are easy to manufacture, and have a sufficiently long history in the field of industrial engineering that many useful options, alterations, features, and associated inventions have been devised to use in conjunction with them. However, the low density of MPW and IPW feedstock (as low as 25 kg/m³ in its uncompressed state) often means that hopper or silo based systems would need to be prohibitively large to provide the required feed rate of industrial pyrolysis systems (e.g. 3-5 tonnes/hr).

In addition, greater problems can arise when the effects of compression are taken into account, both self-compression when a mass of feedstock is pressing down on feedstock lower in a pile and, in particular, compression arising from feedstock being constrained by hopper or silo walls as the hopper or silo is filled. MPW typically consists of shredded flakes of plastic films but can be any form of suitable polymer, often fibres, flakes or rigids bodies, with the majority of the composition by weight typically comprising a mixture of polyethylene and/or polypropylene. The feedstock can have a moisture content as high as 25% and can have metals and sand entrained in various sizes. In small volumes the resultant bulk material is low density even when shredded and when poured forms piles much like other standard materials like sand (see FIG. 1), said piles having an angle of repose. However, MPW is highly compressible (it can easily be compressed to 2-3× its unconstrained density) meaning that when stored in traditional tall and narrow silos the material at the bottom of the silo becomes compressed under the weight of the materials above it, at which point strong particle-to-particle bonds cause the angle of repose to increase, easily reaching 90 degrees (i.e. it will stand up on its own, see FIG. 2).

Increasing angle of repose gives rise to well-known unhelpful behaviour of materials in hoppers and silos. For instance, there is the phenomenon of “rat holing”, depicted in FIG. 3, wherein bulk materials 20 under compression form a self-supporting column, such that when a valve, port, or other point of extraction 30 is opened at the bottom of a hopper or silo 10 to dispense the material, only feedstock in the area above the opening funnels through leaving a significant amount of material remains on the sides of the hopper or silo. Though the hopper or silo can then at least be refilled once this has happened, this still means that less material is dispensed each time the hopper or silo is opened than the hopper or silo is intended to provide.

Another highly undesirable phenomenon is bridging, depicted in FIG. 4, which occurs as a result of materials experiencing significant particle-to-particle bonds are confined within the walls of a vessel under compression. The gravitational force on the material is distributed, establishing a force between the material and the walls of the vessel. In the context of a hopper or silo 10, if there is sufficient force exerted between the bulk material 20 and the walls, the bulk material can form a “bridge” 40 which is stabilised, much as an arch bridge is stabilised by transferring the weight of the bridge and its loads partially into a horizontal force confined by its abutments. When such a bridge is formed in a hopper or silo, only material beneath the bridge is dispensed when a valve, port, or other point of extraction 30 is opened, with the material of the bridge and above the bridge remaining stuck in the hopper or silo (see FIG. 4).

This means when a standard hopper is emptied from the bottom (most commonly from a single horizontal screw auger which is a standard method of conveying bulk materials), materials immediately adjacent to the screw are removed but the materials just beyond this do not fall down to replace the initially removed materials, so the screw auger quickly runs dry and no more materials can be removed from the silo. Even worse, because all the material above the “bridge” in the hopper or silo has remained stationary, it may be impossible to refill the hopper or silo once the bridge has formed- and even if there were space to add more material, adding more may inadvertently make the bridge stronger by providing a greater compressing gravitational force. The hopper or silo is effectively useless unless and until the bridge is disrupted.

Bridging is a well-known phenomenon in hoppers and silos, and therefore various prior art de-bridging techniques exist. However, typical de-bridging techniques that prove effective with other feedstocks (such as vibration or extracting the base of the feedstock) do not work well with MPW, since this feedstock has a tendency to conglomerate such that the main bulk of the material stays intact. For example, a rotating device with ‘fingers’ will simply leave caverns in the structure of the material rather than moving it down. An alternative method, pneumatic injection, is potentially suitable, but would require an inert gas in this application and thus is prohibitively expensive.

There is therefore a long-felt need for systems which can allow MPW, IPW, and materials with similar properties to be handled using conventional tall vertical hoppers and silos (thereby avoiding the restrictive constraints of extrusion), whilst overcoming the difficulties posed by these feedstocks' properties. When utilised in conjunction with a pyrolysis process, such systems must be capable of continuously delivering the feedstock safely into an oxygen deficient atmosphere.

### SUMMARY OF THE INVENTION

The invention firstly provides a hopper system for providing a continuous flow of feedstock, comprising at least one primary hopper comprising an inlet valve, a secondary hopper comprising a multi screw base, and an extraction screw, wherein the multi screw base is configured to convey feedstock towards the extraction screw, and the extraction screw is configured to receive feedstock from the multi screw base and convey it out of the secondary hopper, and at least one full cross sectional area valve, such that each of the at least one primary hoppers has a respective one of the at least one full cross sectional area valves arranged between it and the secondary hopper, wherein each of the at least one primary hoppers is disposed above its respective one of the at least one cross sectional area valves, and the secondary hopper is disposed below the at least one cross sectional area valves.

Preferably, the secondary hopper may be sealed against external atmosphere. Where this is the case, preferably each of the at least one primary hoppers is in communication with a source of inert gas. Where this is the case, the system may preferably further comprise a further screw configured to receive feedstock from the extraction screw and convey it to a pyrolysis reactor.

The invention also relates to a method of operating a hopper system as described above, comprising the steps of opening an inlet valve of one of the at least one primary hoppers to permit feedstock to enter the one of the at least one primary hoppers, closing the inlet valve, opening the respective one of the at least one full cross sectional area valves of the one of the at least one primary hoppers to permit the feedstock to fall into the secondary hopper, operating the multi screw base of the secondary hopper to convey the feedstock to the extraction screw; and operating the extraction screw to remove the feedstock from the secondary hopper.

Where the primary hoppers are in communication with a source of inert gas, the method may preferably further comprise a step of purging the one of the at least one primary hoppers with inert gas subsequent to closing the inlet valve and prior to opening the respective one of the at least one full cross sectional area valves of the one of the at least one primary hoppers.

Although the methods and systems of the present invention may be used in conjunction with any feedstock, the method may preferably be performed where the feedstock is mixed plastic waste or industrial plastic waste. Where this is the case, it may optionally be the case that at least 50% of the feedstock by weight is polyethylene and/or polypropylene.

Another aspect of the invention is a hopper comprising an anti-bridging system, comprising a plate comprising at least one opening arranged to divide the hopper into an upper region and a lower region, a shaft arranged to rotate the plate, and a radial bar attached to a wall of the hopper in the upper region.

Preferably, the plate may further comprise protrusions extending into the lower region.

The invention also relates to a method of preventing bridging in a hopper comprising such an anti-bridging system, comprising causing the shaft to rotate the plate.

The anti-bridging system described above is also compatible with the hopper system described above, so one or more of the primary hoppers may be a hopper comprising the anti-bridging system.

### DESCRIPTION OF DRAWINGS

FIG. 1 depicts bulk material in a pile, illustrating the concept of angle of repose.

FIG. 2 depicts MPW in a pile, exhibiting an extreme angle of repose.

FIG. 3 is a depiction of the concept of ratholing.

FIG. 4 is a depiction of the concept of bridging.

FIG. 5 depicts a hopper system according to the present invention.

FIGS. 6 and 7 depict a hopper comprising an anti-bridging system according to the present invention.

FIG. 8 depicts a top-down view of an anti-bridging system according to the present invention.

FIG. 9 depicts a primary hopper according to the present invention comprising gas recirculation channels.

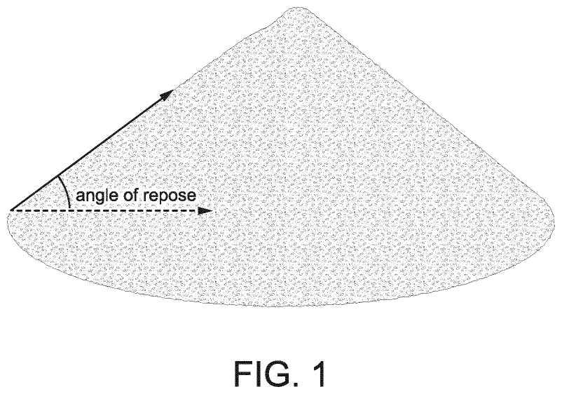

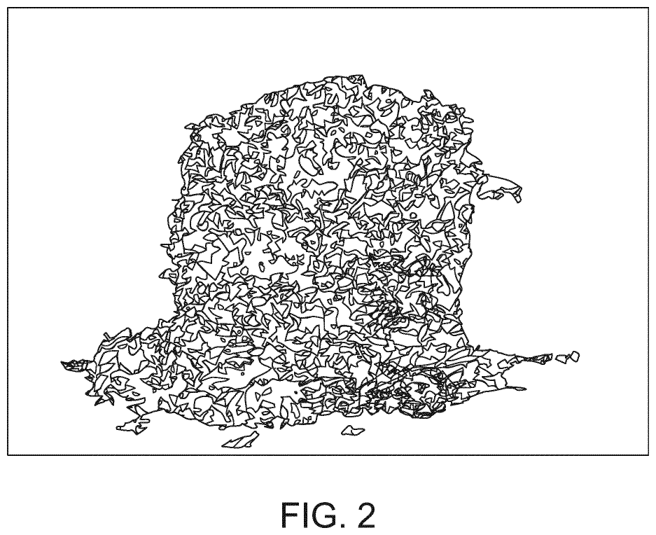

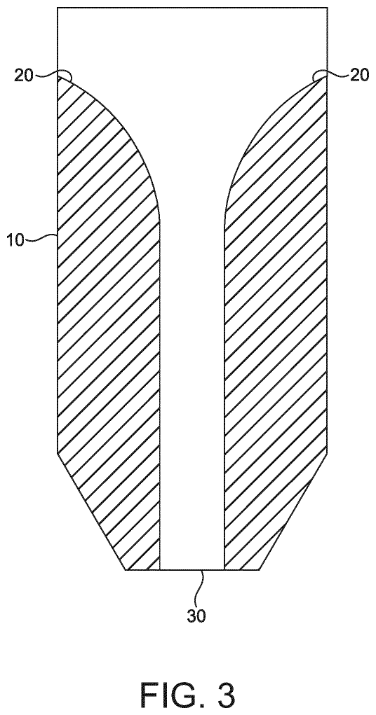

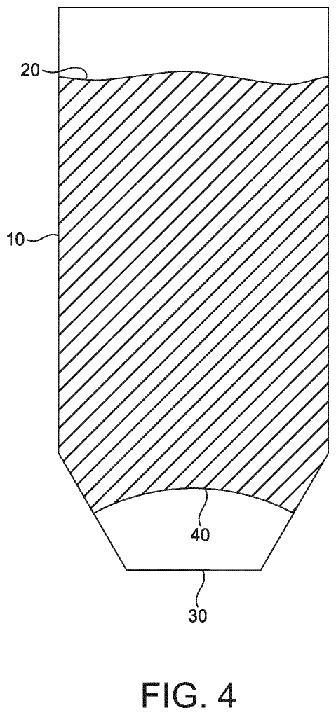

### DETAILED DESCRIPTION

The invention relates to various systems and methods for the better handling of feedstocks, especially useful for MPW and IPW feedstocks. Particular additional features are especially suited for use in conjunction with a pyrolysis reactor.

### Hopper System for Providing Feedstock to Pyrolysis Reactor

A feedstock entry system for a continuous pyrolysis process must be capable of continuously delivering a feedstock safely into an oxygen deficient atmosphere. The current invention satisfies these constraints, and safely feeds a continuous pyrolysis system whilst using considerably less energy (and therefore lower operating costs) than an extrusion system. It has minimal maintenance requirements, and the required energy may be sufficiently low that the energy can partially or entirely provided as a by-product of the pyrolysis process (for example, by generating electricity from by-product gas), allowing the feedstock entry system to be self-sustaining during operation.

The present invention combines existing solutions with innovative designs and applies them to an application that has proved too difficult for these types of hopper/silo systems alone in the past. This allows a huge range of densities and contamination to be fed into the pyrolysis system, so a huge range of feedstock can be utilised in any physical form including agglomerate, flakes, and fibres.

Although this example is in the context of provision of feedstock to a pyrolysis reactor, it will be appreciated that systems as discussed here are equally useful for any context where a continuous supply of feedstock or bulk material is required, especially in a controlled atmosphere. Likewise, whilst the system is especially suited to the problems of handling MPW or IPW, it will also be useful for handling any feedstock or bulk material prone to the problems caused by MPW or IPW, such as bridging or ratholing.

The system is a batch fed continuous system, that converts a batch feeding system into a continuous feed for the pyrolysis reactor.

The system comprises one or more primary hoppers 102, positioned directly above a secondary hopper 104, with each primary hopper 102 having a corresponding full cross sectional area valve 106 controlling the passage of material between its respective primary hopper 102 and the secondary hopper 104. The primary hopper(s) 102 each comprise a respective inlet valve 108 which separates the external atmosphere from the internal atmosphere. This is particularly useful for uses such as providing feedstock to a pyrolysis reactor, in which case it is important that the internal atmosphere is oxygen deficient (since the external atmosphere would typically be oxygen rich).

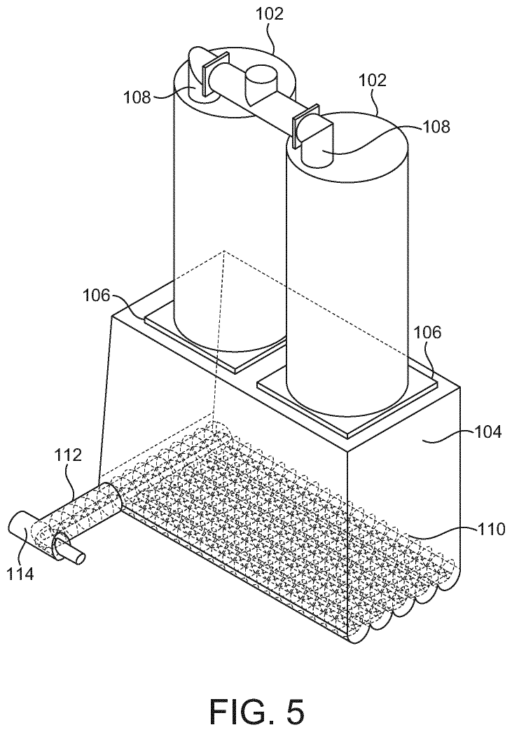

A version of this system comprising two primary hoppers 102 is depicted in FIG. 5. When the system is operated with multiple primary hoppers 102, the loading process works as follows:

During a load sequence, the inlet valve 108 opens, allowing feedstock to fill a first primary hopper 102 until a particular load point before the valve 108 closes. The second primary hopper 102 is then filled in the same way. If additional primary hoppers 102 are present, they are then filled in turn. Either way, the hoppers' sizing, rate of filling, and rate of extraction are selected such that filling occurs continuously for all primary hoppers 102 present.

Once a first primary hopper 102 of the system is full and its respective inlet valve 108 is closed the first primary hopper 102 is purged with inert gas before a transfer to the secondary hopper 104 can begin. This transfer consists of the first primary hopper 102 emptying into the secondary hopper 104 after the full cross sectional area valve 106 controlling passage between the two opens. A pressure differential can be held by injecting inert gas into the first primary hopper 102 during this transfer.

After the feedstock has been transferred and valve 106 closed, a pressure test is conducted to test the seal on the full cross sectional area valve 106 between the first primary hopper 102 and secondary hopper 104. Once confirmed, the first primary hopper 102 can be loaded again, and the second primary hopper 102 can begin the transfer process. Then, once the second primary hopper 102 has completed its transfer process, any further primary hoppers 102 present can begin the transfer process in sequence. The fill rate and transfer rate of the primary hoppers 102 is selected such that once the final primary hopper 102 present has completed its transfer, the first primary hopper 102 is ready to begin its transfer. Preferably, two or more primary hoppers 102 are utilised with cycle times selected to establish an effectively continuous flow of feedstock into the secondary hopper 104. Overlap in the timing of the cycles may be provided so as to provide a margin for error.

Typically, the load and purge process may occur immediately after a transfer. The commencement of a transfer process may occur on the basis of a timed schedule, or may be triggered by a sensor signal. In some examples, this sensor signal may be a level signal from the secondary hopper 104.

The full cross sectional area valve 106 is important as this removes the need for sloping or feed screws, eliminating rat holing (since there is no surface for the ratholed material to support itself on) and significantly reducing (potentially eliminating) bridging.

It should be noted that it is possible to create a system according to the present invention comprising only one primary hopper 102. In this instance, one must oversize the filling process to allow for purge time and keep up with the rate of transfer away from the secondary hopper 104. In such arrangements, although the transfer from the single primary hopper 102 to the secondary hopper 104 is a batch process, a continuous supply of feedstock from the secondary hopper 104 to a pyrolysis reactor can be maintained simply by ensuring that enough material is transferred to the secondary hopper to maintain a sufficient level of buffer material.

However, utilising more than one primary hopper 102 reduces fill cycle time and equipment specification/requirements so that whilst one vessel is being filled with product, another is being purged. This also adds redundancy in case one seal is compromised, or a mechanical problem arises in a hopper. The primary vessels 102 may be either cylindrical or have a non-circular cross-section, as long as a suitable full cross sectional area valve 106 can be accommodated. Cylindrical hoppers have the benefit of utilising the full extent of the anti-bridging dynamic plate hereby described. The utilisation of multiple primary hoppers 102 with a staggered process of filling, purging, and transfer to the secondary hopper 104 allows the system to receive material into the primary hoppers 102 on a batch feeding basis, but obtain an effectively continuous feed from the secondary hopper 104 to the pyrolysis reactor.

The transfer from primary hopper 102 to secondary hopper 104 is of particular sensitivity, as moving MPW/IPW at a high flow rate within a sealed unit is difficult. The footprint of using multiple flat bottomed multi screw hoppers would be prohibitive, with prohibitive capital and operational cost and potential for failure from a lack of redundancy and moving parts; the present invention avoids this difficulty through its arrangement of one or more primary hoppers 102 of a much more simple design feeding into a single secondary hopper 104 with the flat bottomed multi screw feature.

Utilising multiple primary hoppers 102 requires a suitably sized secondary hopper 104 that can accommodate the full volume of the primary hoppers 102 and optimise footprint, therefore a hopper comprising a flat bottomed multi screw base 110 was chosen. This type of hopper can be modified to be sealed from the external atmosphere. The multi screw base 110 transfers feedstock towards one side of the secondary hopper 104, from which feedstock is extracted from the secondary hopper 104 using an extraction screw 112 perpendicularly positioned with respect to the screws of the multi screw base 110. The rpm of the extraction screw 112 can be modified to feed the pyrolysis reactor at the desired rate. The extraction screw 112 extends into a contained pipe, thus maintaining a full flight of feedstock and reducing back flow of gases, though it should be noted that a plug formation is not sought as this cannot be relied upon with MPW/IPW. Therefore it is advisable to keep a positive pressure differential between the secondary hopper 104 and the pyrolysis reactor using an inert gas trickle.

The extraction screw 112 may feed feedstock directly into the pyrolysis reactor. Alternatively, the extraction screw 112 may optionally feed a further screw 114 directly connected to the pyrolysis reactor. Further screw 114 may be a high-speed auger that moves feedstock into the pyrolysis reactor faster than it is received from the perpendicular screw 112. The length of the further screw 114 ensures that the main body of the secondary hopper 104 is set at a distance from the main heated part of the pyrolysis reactor, in order to avoid heat from the pyrolysis reactor travelling back into the secondary hopper 104, which may cause difficulties such as melting of feedstock whilst it is still in the secondary hopper 104. Equally important is the fast movement of feedstock into the pyrolysis reactor from the high-speed auger 114 which takes any absorbed heat into the pyrolysis reactor. The high-speed auger 114 and connected pipe from the perpendicular screw 112 can be jacketed with cold water. The use of the further screw 114 also enhances ease of maintenance access and is beneficial for plant packaging, since it allows the secondary hopper 104 to be positioned away from the pyrolysis reactor axis, which is where maintenance axis is mainly required. Preferably, the perpendicular screw 112 may be attached by a flange to the further screw 114 so that this flange can be undone to provide easier maintenance access.

The design of the primary hoppers 102 allows a reduced operating cost and footprint from existing solutions such as multiple multi-screw bed hoppers, whilst solving issues of sealing problems, and this also allows for a simple transfer without the need to stop and start screws.

A number of useful optional features can be used in conjunction with hoppers according to the present claims. For instance, instead of the extraction screw 112 feeding bulk material towards a further screw 114, as an alternative a drop down feature such as a chute with a square flange can be provided to convey bulk material from the end of the extraction screw 112 to its destination.

Similarly, although in the accompanying drawings the extraction screw 112 is depicted at being at one end of the base of the secondary hopper 104, this is not essential provided that the multi screw base 110 is appropriately designed to convey bulk material to the extraction screw. Indeed, the extraction screw 112 may be placed at any location along the base of the hopper (including a central position), depending on the required layout of the secondary hopper 104.

Optionally, a pipe or other connection between the primary hopper 102 and secondary hopper 104 may be provided so as to allow gas recirculation between the two.

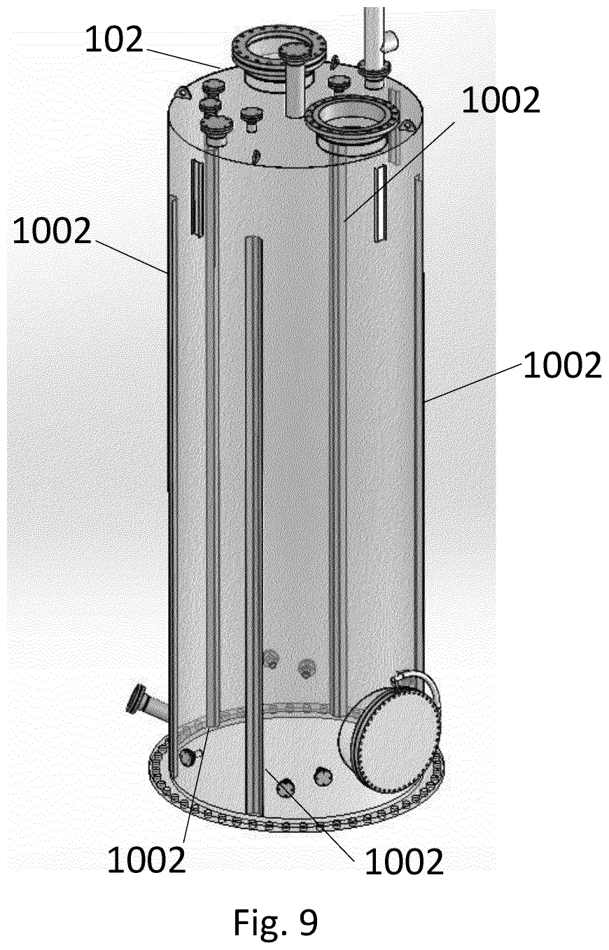

Optionally, as depicted in FIG. 9, the primary hopper 102 may be provided with internal gas recirculation channels 1002 to allow pressure to be equalised as feedstock drops from the primary hopper 102 to the secondary hopper 104.

### Anti-Bridging Plate

The prevention of bridging within a hopper during the handling of MPW and IPW is a particular problem. Due to the high compressibility of these materials, along with the large increase in repose angle as compression increases they exhibit, traditional de-bridging systems are difficult to implement in relation to these materials.

For instance, mechanical de-bridging systems such as rotating mechanical shovels or fingers are known. However, the high compressibility of MPW and IPW, along with their high repose angle, means such systems may simply cause caverns in the material due to its high compressibility and ability to support its own weight.

Another known de-bridging method is pneumatic injection, in which air or an inert gas is forced through the material in order to disrupt any bridges formed. In any system feeding into a pyrolysis reactor, an inert gas would have to be used due to the need to maintain an oxygen deficient atmosphere—hence the step of purging described previously.

In addition, pneumatic injection is a highly wasteful process. Even in systems adapted to provide feedstock to a pyrolysis reactor, and therefore purged with inert gas to maintain an oxygen deficient atmosphere, pneumatic de-bridging systems are not suitable, for this purging occurs when there is no movement of feedstock; consequently, little is accomplished by attempting to perform pneumatic injection-based de-bridging at the same time as purging. The purge must be completed before permitting the feedstock to exit the hopper, and once feedstock removal commences, to use pneumatic de-bridging it will be necessary to apply additional inert gas, forced through the feedstock itself. This uses a significant amount of extra gas and therefore is a highly inefficient use of resources.

The herein described anti-bridging dynamic plate solution allows a standard construction tall and narrow hopper/silo to be reliably emptied at lower cost, higher reliability and gives more flexibility in plant layout then existing options. Although potentially usable with any bulk material which may otherwise be prone to bridging, it is especially useful with respect to the handling of MPW, IPW, and materials with comparable properties to MPW and IPW. It may be used in conjunction with any suitable means for extracting such materials from a hopper once they are required for use. Such means include, but are not limited to, screw-based removal systems, conveyor removal systems, and valve-based removal systems, including full cross sectional area valves. This design allows for any particle size, density and type.

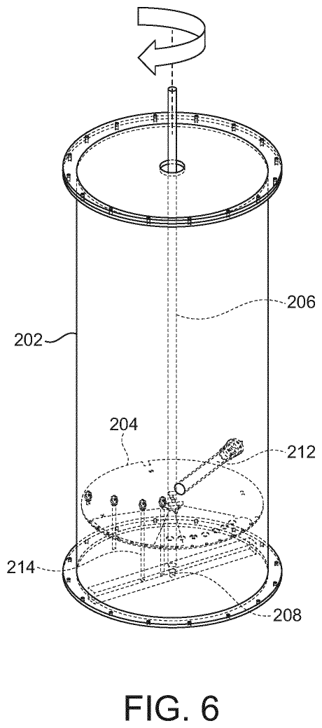

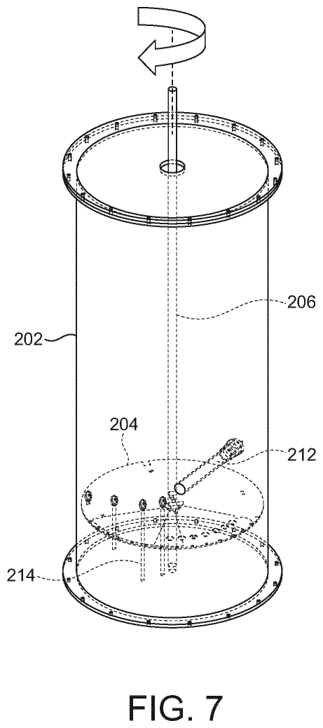

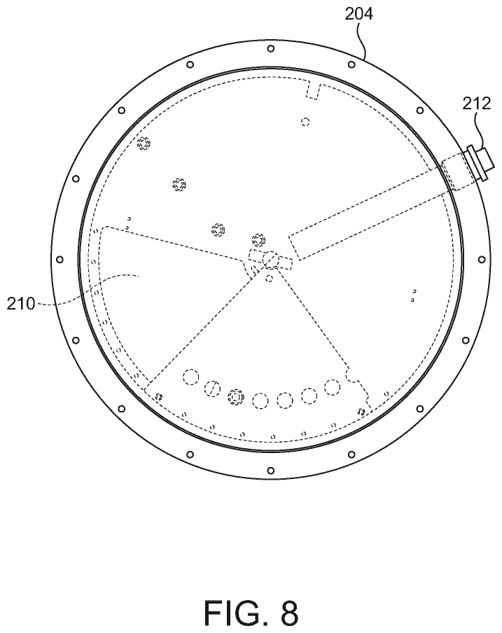

Examples of hoppers comprising an anti-bridging plate are depicted in FIGS. 6-7, and FIG. 8 provides a top-down view of a plate. The depicted examples comprise a hopper 202 with an internal plate 204 fitted across almost the full width of the hopper 202, the plate 204 configured to rotate about the main vertical axis of the hopper 202. A small amount of clearance between the outer diameter of the plate 204 and the inner surface of the hopper 202 is left. The plate is driven by a shaft 206 coming down from the lid of the hopper 202.

The assembly can either be supported by hanging down from the lid (as in FIG. 6b), or rest on a bearing 208 underneath the plate 204, which may be mounted on a crossbeam as shown in FIG. 6.

The internal plate 204 effectively divides the hopper 202 into two sections. Above the plate the feedstock piles up and self-compresses as normal. Below it is a region with more space, as the plate prevents most of the material from accessing this region. The internal plate 204 has one or more openings in it (210) such that when the plate rotates about its central axis the material above the plate 204 can fall through the opening 210 into the lower region, where it can then be stored, conveyed away (e.g. by a screw auger or by falling through an opened valve) or processed by some ancillary machinery. The rate of material being transferred through the plate is controlled by the speed of rotation of the plate, and by the size and number of openings 210.

Another important part of the system is the radial bar 212. Due to the low density of the material, it can show a tendency to rotate with the plate 204 as that rotates about its main axis, meaning there is no relative motion between the material and plate 204 and therefore no transfer of material through the opening(s) 210. By fixing radial bar 212 radially to the hopper 202 walls close to the upper surface of the plate 204, the material interacts with the radial bar 212 and cannot rotate around with plate 204, causing tumbling and relative motion between the materials and plate 204. This causes the material to fall through the gap 210 in plate 204. The tumbling action of the feedstock material as it flows around the radial bar 212 may have a beneficial effect of disrupting bridging in the material above the radial bar 212.

Plate 204 and/or shaft 206 can have protrusions 214 mounted to them in the region below the plate 204. The rotational motion of these protrusions 214 aid movement of the materials that build up in the lower region of the hopper 202 and prevents any stagnation of materials here before it is removed from the hopper 202 or processed further.

The overall effect of the anti-bridging plate 204 as depicted is that the plate 204 establishes a roof over the top of the lower section of the hopper 202, whereby the feedstock material in the lower section is shielded from compaction as a result of the compressive force of the feedstock contained above the plate 204. This limits how much compaction occurs in the lower region. The compressive force is what would otherwise cause bridging, and therefore bridging is discouraged or indeed prevented altogether by the reduction or removal of this compressive force.

The solution is especially effective with MPW, IPW, and materials which show a similar property of having their angle of repose increase significantly under compression. The lower the angle of repose, the less likely it is for bridging (or rat holing) to take place, and the more predictable in general the behaviour of the feedstock material.

Bridging can be further discouraged in this region by ensuring that feedstock is evacuated from it (e.g., by a screw auger, by falling through a valve, or by any other means of extracting feedstock from the hopper 202) at a faster rate than the feedstock enters the lower section, said rate being controlled by the size of the one or more openings 210 in the plate 204 and the rate of rotation of the plate 204. By ensuring this, it is impossible for the feedstock to accumulate into a pile in the lower region of the hopper 202, and consequently bridging is avoided.

Various variations of anti-bridging solutions according to the present invention are possible. For example:
Hopper 202 could have a circular cross section, or some other shape (e.g. square). It could have a constant cross section or be tapered (either increasing or reducing in cross section along its length)
Plate 204 could cover the entire width of the hopper internally, or only some proportion of it. It could be mounted coaxially within the hopper or offset from the main vertical axis in some way. It could be circular in shape or some other shape that fits within the internal walls of hopper 202.
Shaft 206 can pass through the hopper lid coaxial to the main hopper vertical axis, or be offset in some way (e.g. using universal joints) if the centre of the hopper lid is required to be used for some other purpose. Or even turn through 90 degrees (e.g. using a bevel gearbox) and exit the hopper radially through its side wall somewhere, leaving the lid free for other purposes.
Shaft 206 can be driven in a variety of ways (electric motor, chain and sprocket, hydraulic/pneumatic motor).
Lower support bearing 208 can exist or not exist.
Plate openings 210 can vary in size, shape and number.
Radial bar 212 can vary in length, cross section, position relative to plate 204 (radially, height offset). More than one radial bar may be provided.
Protrusions 214 can be mounted either to plate 204 or shaft 206 (or both), vary in position, number, cross section, shape, or be absent altogether.
The whole assembly can be made liquid and/or gas tight for applications involving hazardous substances or requiring a controlled internal atmosphere.
Sensors (for detecting the level of materials inside the hopper 202) could be mounted to the hopper walls in any location. Downwards-facing sensors (e.g. radar, ultrasonic sensors) could be mounted to the underside of the hopper lid to detect the height of materials stored in the upper section of the hopper 202.

### Use of Anti-Bridging Plate in Conjunction With Hopper System

Hopper systems as described above under “Hopper System For Providing Feedstock To Pyrolysis Reactor”, as previously mentioned, can greatly reduce the occurrence of bridging. However, in some cases they may not entirely eliminate it. In particular, the highly unusual behaviour of MPW and IPW (arising in part from the fact that, by definition, mixed plastic waste has an essentially unpredictable composition) can still cause bridging to occur in the primary hoppers 102. In addition, imperfections of manufacture of the primary hoppers 102 may give rise to regions of the primary hopper walls 102 where bridging is unusually likely to occur (comparable, for example, to the way imperfections on surfaces can give rise to nucleation sites).

To eliminate any possibility of bridging, it is possible to use an anti-bridging plate 204 in conjunction with such hopper systems-for instance, the primary hopper(s) 102 of the hopper system may each be provided with a respective anti-bridging plate 204.

1. A hopper system for providing a continuous flow of feedstock, comprising:
at least one primary hopper comprising an inlet valve;
a secondary hopper comprising a multi screw base and an extraction screw, wherein the multi screw base is configured to convey feedstock towards the extraction screw, and the extraction screw is configured to receive feedstock from the multi screw base and convey it out of the secondary hopper; and
at least one full cross sectional area valve, such that each of the at least one primary hoppers has a respective one of the at least one full cross sectional area valves arranged between it and the secondary hopper;
wherein each of the at least one primary hoppers is disposed above its respective one of the at least one cross sectional area valves, and the secondary hopper is disposed below the at least one cross sectional area valves.

2. The hopper system of claim 1, wherein the secondary hopper is sealed against external atmosphere.

3. The hopper system of claim 2, wherein each of the at least one primary hoppers is in communication with a source of inert gas.

4. The hopper system of claim 3, further comprising a further screw configured to receive feedstock from the extraction screw and convey it to a pyrolysis reactor.

5. A method of operating the hopper system of claim 1, comprising:
i) opening an inlet valve of one of the at least one primary hoppers to permit feedstock to enter the one of the at least one primary hoppers;
ii) closing the inlet valve;
iii) opening the respective one of the at least one full cross sectional area valves of the one of the at least one primary hoppers to permit the feedstock to fall into the secondary hopper;
iv) operating the multi screw base of the secondary hopper to convey the feedstock to the extraction screw; and
v) operating the extraction screw to remove the feedstock from the secondary hopper.

6. The method of claim 5, wherein each of the at least one primary hoppers is in communication with a source of inert gas, and wherein the method further comprises a step of purging the one of the at least one primary hoppers with inert gas subsequent to closing the inlet valve and prior to opening the respective one of the at least one full cross sectional area valves of the one of the at least one primary hoppers.

7. The method of claim wherein the feedstock is mixed plastic waste or industrial plastic waste.

8. The method of claim 7, wherein at least 50% of the feedstock by weight is polyethylene and/or polypropylene.

9. A hopper comprising an anti-bridging system, comprising:
a plate comprising at least one opening arranged to divide the hopper into an upper region and a lower region;
a shaft arranged to rotate the plate;
a radial bar attached to a wall of the hopper in the upper region.

10. The hopper of claim 9, wherein the plate further comprises protrusions extending into the lower region.

11. A method of preventing bridging in the hopper of claim 9, or comprising causing the shaft to rotate the plate.

12. The hopper system of claim 1, wherein at least one of the at least one primary hoppers is a hopper comprising an anti-bridging system, comprising:
a plate comprising at least one opening arranged to divide the hopper into an upper region and a lower region;
a shaft arranged to rotate the plate; and
a radial bar attached to a wall of the hopper in the upper region.
